(19) United States
(12) Patent Application Publication
(10) Pub. No.: US 2024/0348716 A1
(43) Pub. Date: Oct. 17, 2024

(54) Riding Tool Identification Method and Device

(71) Applicant: Honor Device Co., Ltd., Shenzhen (CN)

(72) Inventors: Haoxuan Di, Shenzhen (CN); Junlong Guo, Shenzhen (CN); Danhong LI, Shenzhen (CN); Xiaowu Zhang, Shenzhen (CN)

(21) Appl. No.: 18/037,131

(22) PCT Filed: Dec. 15, 2022
(86) PCT No.: PCT/CN2022/139339

§ 371 Date: May 16, 2023

(30) Foreign Application Priority Data
Jan. 5, 2022 (CN) 202210006782.4

(51) Int. Cl. H04M 1/72454; G10L 15/22

(52) U.S. Cl. CPC H04M 1/72454; G10L 15/22; G10L 2015/223

(57) ABSTRACT

This application provides a riding tool identification method and a device. The method includes: obtaining at least one of an acceleration signal acquired by an acceleration sensor and a magnetometer signal acquired by a magnetometer sensor in an electronic device; identifying a riding tool based on at least one of an acceleration feature and a magnetometer feature, to obtain a riding classification result, where the acceleration feature is obtained based on the acceleration signal, and the magnetometer feature is obtained based on the magnetometer signal; obtaining a voice signal acquired by a microphone in the electronic device, and extracting a voice feature based on the voice signal; recognizing a voice broadcast during ride based on the voice feature, to obtain a voice broadcast recognition result; and determining a category of the riding tool based on the riding classification result and the voice broadcast recognition result.

### CROSS-REFERENCE TO RELATED APPLICATIONS

This application is a national stage of International Application No. PCT/CN2022/139339, filed on Dec. 15, 2022, which claims priority to Chinese Patent Application No. 202210006782.4, filed on Jan. 5, 2022. The disclosures of both of the aforementioned applications are hereby incorporated by reference in their entireties.

### TECHNICAL FIELD

This application relates to the field of data processing technologies, and in particular, to a riding tool identification method and a device.

### BACKGROUND

Currently, a user may move to a target position in a manner such as walking, running, cycling, and riding, and a user's way of travelling may be identified through an electronic device carried by the user. The electronic device may acquire a speed and location information, for example, global positioning system (Global Positioning System, GPS) information. The electronic device identifies the user's way of travelling based on the speed and the location information. The user may ride at least one of a metro, a high-speed railway, a bus, and a car. However, a category of a riding tool cannot be identified based on the speed and the location information.

### SUMMARY

This application provides a riding tool identification method and a device, to resolve a problem that an electronic device cannot identify a category of a riding tool based on a speed and location information.

To achieve the foregoing objective, this application provides the following technical solutions.

According to a first aspect, this application provides a riding tool identification method. The method includes: obtaining at least one of an acceleration signal acquired by an acceleration sensor and a magnetometer signal acquired by a magnetometer sensor in an electronic device; identifying a riding tool based on at least one of an acceleration feature and a magnetometer feature, to obtain a riding classification result, where the acceleration feature is obtained based on the acceleration signal, and the magnetometer feature is obtained based on the magnetometer signal; obtaining a voice signal acquired by a microphone in the electronic device, and extracting a voice feature based on the voice signal; recognizing a voice broadcast during ride based on the voice feature, to obtain a voice broadcast recognition result; and determining a category of the riding tool based on the riding classification result and the voice broadcast recognition result.

The acceleration feature may be an acceleration value, and the magnetometer feature may be a geomagnetic amplitude. In this embodiment, the electronic device may fuse at least one sensor signal and a voice signal, to identify a category of the riding tool. For example, the electronic device may fuse the acceleration signal, the magnetometer signal, and the voice signal, to identify a category of the riding tool, thereby improving accuracy through a plurality of signals. For example, in a process of identifying a riding tool, the electronic device may add the voice feature extracted based on the voice signal to assist a riding tool that is difficult to distinguish based on the acceleration feature and/or the magnetometer feature, to refine the category of the riding tool, thereby improving the accuracy and an identification function. For example, the electronic device may determine, based on the voice feature, that the voice broadcast recognition result is at least one of a metro voice broadcast, a bus voice broadcast, and a high-speed railway voice broadcast, or determine the voice broadcast recognition result is a metro voice broadcast or a bus voice broadcast, and effectively distinguish between a high-speed railway or a metro based on the voice feature when the high-speed railway and the metro are difficult to be distinguished based on the acceleration feature. Similarly, when a bus and a car are difficult to be distinguished based on the acceleration feature and the magnetometer feature, a bus voice broadcast may be recognized based on the voice feature, thereby effectively distinguishing between the bus and the car. When the electronic device may identify ride of a bus or a metro, a bus ride code may be pushed after the bus or the metro arrives at a station, to improve accuracy and timeliness of pushing a ride code, thereby improving user experience. The metro voice broadcast may be a metro arrival broadcast, and the bus voice broadcast may be a bus arrival broadcast. Certainly, the metro voice broadcast and/or the bus voice broadcast may alternatively be a voice broadcast during travelling or an out-of-station broadcast.

In addition, riding tools of different categories have different magnetometer features. The magnetometer feature may represent a fluctuation of a geomagnetic amplitude, and fluctuations of geomagnetic amplitudes of riding tools of different categories are different. For example, during start and stop of a metro, a geomagnetic amplitude may greatly fluctuate due to electromagnetic induction. During start and stop of a high-speed railway, a geomagnetic amplitude fluctuates due to electromagnetic induction, but the fluctuation of the geomagnetic amplitude of the high-speed railway is less than the fluctuation of the geomagnetic amplitude of the metro. During start and stop of a bus and a car, geomagnetic amplitudes may also fluctuate. Since there is no electromagnetic induction or electromagnetic induction is weak, fluctuations of geomagnetic amplitudes of the bus and the car are less than the fluctuation of the geomagnetic amplitude of the high-speed railway. Therefore, the magnetometer feature reflecting a fluctuation of a geomagnetic amplitude is introduced into identification of a category of the riding tool, to effectively distinguish between riding tools, thereby improving the accuracy of identifying a category of the riding tool.

Optionally, before the identifying a riding tool based on at least one of an acceleration feature and a magnetometer feature, to obtain a riding classification result, the method further includes: detecting whether the electronic device is in a riding state; triggering, if it is detected that the electronic device is in the riding state, the electronic device to identify the riding tool, to obtain the riding classification result; or continuing to detect, if it is detected that the electronic device is in a non-riding state, whether the electronic device is in the riding state. In this way, the identification function is further improved, and a category of the riding tool is identified in the riding state, so that identification of a category of the riding tool in the non-riding state is omitted, thereby reducing power consumption.

Optionally, the method further includes: controlling on and off of the microphone based on whether the electronic device is in the riding state; and/or controlling on and off of the microphone based on a ride code push situation of the electronic device; and/or controlling on and off of the microphone based on an operating status of the electronic device, so that the electronic device may control the on and off of the microphone in at least one manner. In this way, during identification of the riding tool, the microphone may be turned on in some stages, to reduce power consumption caused by an on state of the microphone kept for a long time. For example, the microphone is turned on when the electronic device is in a riding state, and the microphone is turned off when the electronic device is in a non-riding state. When the electronic device is in a non-riding state, the microphone is turned off without operating, thereby reducing power consumption of the electronic device.

Optionally, the controlling on and off of the microphone based on whether the electronic device is in the riding state includes: turning on the microphone if it is detected that the electronic device is in the riding state; or turning off the microphone if it is detected that the electronic device is in the non-riding state. When the electronic device is in a riding state, if a voice broadcast recognition result is obtained based on the voice feature, the electronic device may control the microphone to be turned off. An off state of the microphone may be maintained until an end of a riding state, and the voice broadcast recognition result may be maintained until an end of a riding state. The end of a riding state may be drop-off of a user, for example, the electronic device detects that the electronic device is switched from a riding state to a non-riding state. In this way, power consumption of the electronic device is further reduced.

Optionally, the controlling on and off of the microphone based on a ride code push situation of the electronic device includes: turning on the microphone if it is detected that the electronic device enables a ride code push function; or turning off the microphone if it is detected that the electronic device completes push of a ride code; and turning on the microphone every first time period after turning off the microphone, or controlling, after turning off the microphone, on and off of the microphone based on whether the electronic device is in the riding state. The user may ride again after the electronic device pushes a ride code. In this case, when the electronic device is in a riding state, the microphone may be controlled to be turned on again, to identify, based on the voice broadcast recognition result, a riding tool taken by the user, thereby reducing power consumption of the electronic device while improving the accuracy.

Optionally, the controlling on and off of the microphone based on an operating status of the electronic device includes: turning on the microphone if the electronic device is in a screen-on state; or turning off the microphone if the electronic device is in a screen-off state. When the electronic device is in a screen-on state, it is highly likely that the user uses the electronic device, and the user is used to using the electronic device during ride. Therefore, on and off of the microphone may be controlled based on the operating status of the electronic device.

Optionally, the detecting whether the electronic device is in a riding state includes: obtaining a base station signal acquired by a modem processor in the electronic device within a preset time period; detecting, based on the base station signal, a quantity of cells passed by the electronic device within the preset time period; and determining, based on the quantity of cells passed by the electronic device within the preset time period, whether the electronic device is in the riding state, to detect the riding state based on the base station signal. Being in the riding state is determined if the quantity of cells passed by the electronic device within the preset time period is greater than a preset quantity of cells. Generally, a speed of the user when walking, cycling, or running is less than a speed during ride. Correspondingly, within a time period, a movement distance of the user when walking, cycling, or running is less than a movement distance during ride. A larger movement distance may indicate a larger quantity of times of cell handover in the electronic device, and indicate a larger quantity of cells passed by the electronic device within a time period. Based on this, the electronic device may set a preset quantity of cells, and the preset quantity of cells represents a quantity of cells passed within the preset time period when the user may not ride. By comparing with the preset quantity of cells, whether being in a riding state is determined, so that the riding state and the non-riding state may be effectively distinguished based on the quantity of cells passed within the preset time period.

Optionally, the detecting whether the electronic device is in a riding state includes: inputting the acceleration feature into an artificial intelligence riding state identification model to obtain a ride identifier outputted by the artificial intelligence riding state identification model, where the ride identifier indicates whether the electronic device is in the riding state or the non-riding state, and the artificial intelligence riding state identification model is obtained by training based on historical acceleration features of riding tools of different categories. In this embodiment, the artificial intelligence riding state identification model may be obtained by pre-training based on the historical acceleration feature, for example, distinguishing based on historical acceleration features of walking, cycling, running, taking a riding tool such as a high-speed railway, so that the artificial intelligence riding state identification model can effectively distinguish between the riding state and the non-riding state. The ride identifier may be 0 and 1, where 0 indicates being in a non-riding state, and 1 indicates being in a riding state. The artificial intelligence riding state identification model may be a binary classification network model. Outputs of the binary classification network model may be 0 and 1. The artificial intelligence riding state identification model may be obtained by training based on at least one of a decision tree, a support vector machine, logistic regression, and a neural network.

In this embodiment, the electronic device may determine whether being in a riding state based on the acceleration feature and the base station signal. For example, when being in a riding state is determined based on the quantity of cells, and the ride identifier outputted by the artificial intelligence riding state identification model indicates being in a riding state, it is determined that the electronic device is in the riding state; and when being in a non-riding state is determined based on the quantity of cells, and/or the ride identifier outputted by the artificial intelligence riding state identification model indicates being in a non-riding state, it is determined that the electronic device is in the non-riding state, so that the riding state can be detected from a plurality of perspectives, thereby improving the accuracy.

Optionally, the identifying a riding tool based on at least one of an acceleration feature and a magnetometer feature, to obtain a riding classification result includes: inputting at least one of the acceleration feature and the magnetometer feature into an artificial intelligence riding classification model to obtain the riding classification result outputted by the artificial intelligence riding classification model, where the artificial intelligence riding classification model is obtained by training based on at least one of historical acceleration features and historical magnetometer features of the riding tools of different categories, and the riding classification result outputted by the artificial intelligence riding classification model indicates scores of the riding tools of different categories. For example, the artificial intelligence riding classification model may be obtained by training based on the historical magnetometer feature. The historical magnetometer feature may represent a fluctuation of a geomagnetic amplitude, and fluctuations of geomagnetic amplitudes of riding tools of different categories are different. Therefore, the artificial intelligence riding classification model trained based on the historical magnetometer feature can effectively distinguish between categories of riding tools, and certainly, the acceleration feature may further be introduced, to improve the accuracy.

The artificial intelligence riding classification model may output scores of four categories, namely, a high-speed railway, a metro, a bus/car, and an unknown category. The “bus/car” indicates that the riding tool may be a bus, or may be a car. The “unknown category” indicates that a category of the riding tool is not identified or a way of travelling other than riding the metro, the high-speed railway, the bus, and the car is identified. For example, one of ways of travelling such as cycling, walking, and running is identified. For example, the artificial intelligence riding classification model may be a four-classification network model. The four-classification network model may output scores of four categories, namely, a high-speed railway, a metro, a bus/car, and an unknown category. Certainly, the artificial intelligence riding classification model may be a three-classification network model. The three-classification network model may output scores of three categories, namely, a high-speed railway, a metro, and an unknown category, or output scores of three categories, namely, a high-speed railway, a metro, a bus/car.

Optionally, the recognizing a voice broadcast during ride based on the voice feature, to obtain a voice broadcast recognition result includes: inputting the voice feature into an artificial intelligence voice type recognition model to obtain the voice broadcast recognition result outputted by the artificial intelligence voice type recognition model, where the artificial intelligence voice type recognition model is obtained by training based on historical voice features of the riding tools of different categories, and the voice broadcast recognition result indicates a category of a riding tool corresponding to the voice feature. The artificial intelligence voice type recognition model may recognize at least one of voice broadcasts of a high-speed railway, a metro, a bus, and an unknown category, to assist in identifying a riding tool. For example, the artificial intelligence voice type recognition model may be a three-classification network model, and a metro, a bus, and an unknown category are identified. Correspondingly, the electronic device may obtain voice signals of metro arrival and bus arrival in advance. Since voice broadcasts in different cities may be different, the electronic device may obtain voice signals of metro arrival and bus arrival of different cities in advance. In this way, the artificial intelligence voice type recognition model may learn voice characteristics of different cities.

In this embodiment, the voice feature may be a Mel-frequency cepstral coefficient feature. The Mel-frequency cepstral coefficient feature may reflect a voiceprint characteristic of a broadcaster. When the artificial intelligence voice type recognition model is trained by using a historical Mel-frequency cepstral coefficient feature, the artificial intelligence voice type recognition model may learn voiceprint characteristics of different broadcasters, and establish a mapping relationship between the voiceprint characteristic reflected by the voice feature and the broadcaster. After a voice broadcast detection module inputs a currently extracted Mel-frequency cepstral coefficient feature into the artificial intelligence voice type recognition model, the artificial intelligence voice type recognition model may identify a voiceprint feature reflected by the Mel-frequency cepstral coefficient feature. Based on whether the voiceprint feature corresponds to a metro broadcaster or a bus broadcaster, or that the voiceprint feature is not detected, a voice signal may be introduced, so that accuracy of identifying a metro and a bus is improved, and a bus and a car can be distinguished.

Optionally, the recognizing a voice broadcast during ride based on the voice feature, to obtain a voice broadcast recognition result includes: recognizing the voice broadcast during ride based on a broadcast frequency of the voice signal and broadcast frequency thresholds of different riding tools, to obtain the voice broadcast recognition result, where the voice broadcast recognition result indicates a category of a riding tool corresponding to the voice signal. Since a distance between high-speed railway stations is relatively long, a broadcast frequency of a high-speed railway recognized by the voice broadcast detection module is higher than a broadcast frequency of a car, but lower than broadcast frequencies of a metro and a bus; and a broadcast frequency of a metro detected by the voice broadcast detection module is higher than broadcast frequencies of a car, a bus, and a high-speed railway. Based on this, the voice broadcast detection module may identify a riding tool based on broadcast frequencies of voice signals acquired by the microphone. In some cases, a distance between bus stations is relatively short, a broadcast frequency detected by the voice broadcast detection module is relatively high. Similarly, a distance between metro stations is relatively long in some cases, and a broadcast frequency detected by the voice broadcast detection module is relatively low. As a result, a result of the voice broadcast detection module is incorrect, and the accuracy is low although riding tools can be distinguished.

Optionally, the recognizing a voice broadcast during ride based on the voice feature, to obtain a voice broadcast recognition result includes: recognizing the voice broadcast during ride based on key content of the voice signal and preset key content of different riding tools, to obtain the voice broadcast recognition result, where the voice broadcast recognition result indicates a category of a riding tool corresponding to the voice signal. For example, whether the key content is a metro keyword, a high-speed railway keyword, and a bus keyword is detected, and identification is performed through the keywords. However, key content extraction is time-consuming, and more time may be consumed when riding tools are distinguished.

Optionally, the determining a category of the riding tool based on the riding classification result and the voice broadcast recognition result includes: determining, if a high-speed railway score is the largest in the riding classification result, and the high-speed railway score meets a first threshold condition, that the riding tool is a high-speed railway; determining, if a metro score is the largest in the riding classification result, and the metro score meets a second threshold condition, that the riding tool is a metro; determining, if the metro score meets a third threshold condition, and the voice broadcast recognition result is a metro broadcast voice, that the riding tool is the metro; determining, if a bus/car score in the riding classification result meets a fourth threshold condition, and the voice broadcast recognition result is a bus broadcast voice, that the riding tool is a bus; and determining, if the bus/car score in the riding classification result is largest, the bus/car score meets a fifth threshold condition, and the voice broadcast recognition result is not the bus broadcast voice and the metro broadcast voice, that the riding tool is a car. The first threshold condition, the second threshold condition, the third threshold condition, the fourth threshold condition, and the fifth threshold condition may be single thresholds (that is, single values), or may be threshold ranges. If the first threshold condition, the second threshold condition, the third threshold condition, the fourth threshold condition, and the fifth threshold condition are single thresholds, the thresholds may be the same or may be different. For example, a threshold specified by the second threshold condition is greater than a threshold specified by the third threshold condition. If the first threshold condition, the second threshold condition, the third threshold condition, the fourth threshold condition, and the fifth threshold condition are threshold ranges, the threshold ranges may at least partially overlap or may not overlap. That at least partially overlapping means that there are identical values in the threshold ranges.

In a process of identifying a bus and a car, the electronic device may add a time limitation. In a manner, if the bus/car score in the riding classification result meets the fourth threshold condition, and the bus voice broadcast is detected within a first preset duration, the riding tool is determined as a bus. If the bus/car score in the riding classification result is largest, the bus/car score meets the fifth threshold condition, and the bus voice broadcast is not detected within a second preset duration, the riding tool is determined as a car. The second preset duration may be longer than the first preset duration, that is, the second preset duration is selected as a longer time period, and a case in which a distance between bus stations is relatively long, and there is no bus broadcast voice for a relatively long time is excluded, thereby improving the accuracy.

Optionally, the determining, if a high-speed railway score is the largest in the riding classification result, and the high-speed railway score meets a first threshold condition, that the riding tool is a high-speed railway includes: determining, if the high-speed railway score is the largest in the riding classification result, the high-speed railway score meets the first threshold condition, and the base station signal includes a high-speed railway identifier, that the riding tool is the high-speed railway, where the base station signal is acquired by the modem processor in the electronic device. A base station along the high-speed railway uses a high-speed railway private network, and a base station signal sent by the base station includes a high-speed railway identifier. Therefore, the base station signal assists in identifying a high-speed railway, thereby improving the accuracy.

Optionally, the identifying a riding tool based on at least one of an acceleration feature and a magnetometer feature, to obtain a riding classification result includes: identifying the riding tool based on the magnetometer feature and magnetometer thresholds of different riding tools, to obtain the riding classification result. Riding tools of different categories have different magnetometer features. The magnetometer feature may represent a fluctuation of a geomagnetic amplitude, and fluctuations of geomagnetic amplitudes of riding tools of different categories are different. For example, during start and stop of a metro, a geomagnetic amplitude may greatly fluctuate due to electromagnetic induction. During start and stop of a high-speed railway, a geomagnetic amplitude fluctuates due to electromagnetic induction, but the fluctuation of the geomagnetic amplitude of the high-speed railway is less than the fluctuation of the geomagnetic amplitude of the metro. During start and stop of a bus and a car, geomagnetic amplitudes may also fluctuate. Since there is no electromagnetic induction or electromagnetic induction is weak, fluctuations of geomagnetic amplitudes of the bus and the car are less than the fluctuation of the geomagnetic amplitude of the high-speed railway. Therefore, the electronic device may effectively distinguish between riding tools based on the magnetometer feature and the magnetometer thresholds of different riding tools, thereby improving the identification accuracy.

Optionally, the determining a category of the riding tool based on the riding classification result and the voice broadcast recognition result includes: determining, if the riding classification result is a high-speed railway, that the riding tool is the high-speed railway; determining, if the riding classification result is a metro, and the voice broadcast recognition result is a metro broadcast voice, that the riding tool is the metro; determining, if the riding classification result is a bus or a car, and the voice broadcast recognition result is a bus broadcast voice, that the riding tool is the bus; and determining, if the riding classification result is the bus or the car, and the voice broadcast recognition result is not the bus broadcast voice and the metro broadcast voice, that the riding tool is the car. When a bus and a car are difficult to be distinguished based on the riding classification result, the voice broadcast recognition result is introduced to distinguish between the bus and the car, thereby improving the accuracy and refining the category.

Optionally, the determining a category of the riding tool based on the riding classification result and the voice broadcast recognition result includes: determining, if the base station signal includes a high-speed railway identifier, that the riding tool is the high-speed railway, where the base station signal is acquired by the modem processor in the electronic device. A base station along the high-speed railway uses a high-speed railway private network, and a base station signal sent by the base station includes a high-speed railway identifier. Therefore, the base station signal assists in identifying a high-speed railway, thereby improving the accuracy.

According to a second aspect, this application provides an electronic device. The electronic device includes one or more processors and a memory. The memory is configured to store one or more pieces of computer program code, the computer program code includes computer instructions, and the computer instructions, when executed by the one or more processors, cause the electronic device to perform the riding tool identification method.

According to a third aspect, this application provides a computer-readable storage medium. The computer-readable storage medium includes instructions, and the instructions, when run on an electronic device, cause the electronic device to perform the riding tool identification method.

### BRIEF DESCRIPTION OF THE DRAWINGS

FIG. 1 is a schematic diagram of a metro travel scenario according to this application;

FIG. 2 is a diagram of a hardware structure of an electronic device according to this application;

FIG. 3 is an architectural diagram of software and hardware of an electronic device according to this application;

FIG. 4A to FIG. 4C is a timing diagram of a riding tool identification method according to Embodiment 1 of this application;

FIG. 5 is a schematic diagram of a riding tool identification method according to this application;

FIG. 6 is a schematic diagram of detecting a riding state according to this application;

FIG. 7 is a schematic diagram of obtaining a riding classification score according to this application;

FIG. 8 is a schematic diagram of detecting a voice broadcast according to this application;

FIG. 9 is a schematic diagram of identifying a riding tool according to this application;

FIG. 10 is a schematic diagram of a riding tool identification method according to Embodiment 2 of this application; and

FIG. 11 is a schematic diagram of a riding tool identification method according to Embodiment 3 of this application.

### DETAILED DESCRIPTION OF ILLUSTRATIVE EMBODIMENTS

The following clearly and completely describes technical solutions in embodiments of this application with reference to the accompanying drawings in the embodiments of this application. Terms used in the following embodiments are only intended to describe particular embodiments, and are not intended to limit this application. As used in this specification and the claims of this application, a singular expression form, “one”, “a”, “the”, “foregoing”, “said”, or “this”, is intended to also include “one or more” expression form, unless clearly indicated to the contrary in the context. It should be further understood that, in the embodiments of this application, “at least one” means one, two, or more than two. The term “and/or” describes an association relationship between associated objects and represents that three relationships may exist. For example, A and/or B may represent: only A exists, both A and B exist, and only B exists, where A and B may be singular or plural. The character “/” generally indicates an “or” relationship between the associated objects.

Reference to “an embodiment”, “some embodiments”, or the like described in this specification indicates that one or more embodiments of this application include a specific feature, structure, or characteristic described with reference to the embodiments. Therefore, statements such as “in an embodiment”, “in some embodiments”, “in some other embodiments”, and “in other embodiments” in different parts of this specification do not necessarily mean referring to a same embodiment. Instead, the statements mean “one or more but not all of embodiments”, unless otherwise specifically emphasized in another manner. The terms “include”, “comprise”, “have” and their variants all mean “include but are not limited to”, unless otherwise specifically emphasized in another manner.

A plurality of involved in the embodiments of this application refers to two or more. It is to be noted that, in descriptions of the embodiments of this application, terms such as “first” and “second” are merely used for distinguishing descriptions, and cannot be understood as an indication or implication of relative importance, or an indication or implication of a sequence.

In this embodiment, a riding tool may include: a metro, a high-speed railway, a bus, a car, and the like. A user may select a riding tool for travelling. For example, the user may choose to travel by a metro, and after the metro arrives at a station, the user may scan a ride code to get off the station. In this case, an electronic device may enable an arrival ride code push function. After it is identified that the user takes a metro and it is detected that the metro arrives at the station, a metro ride code is pushed. The arrival refers to arrival at a destination.

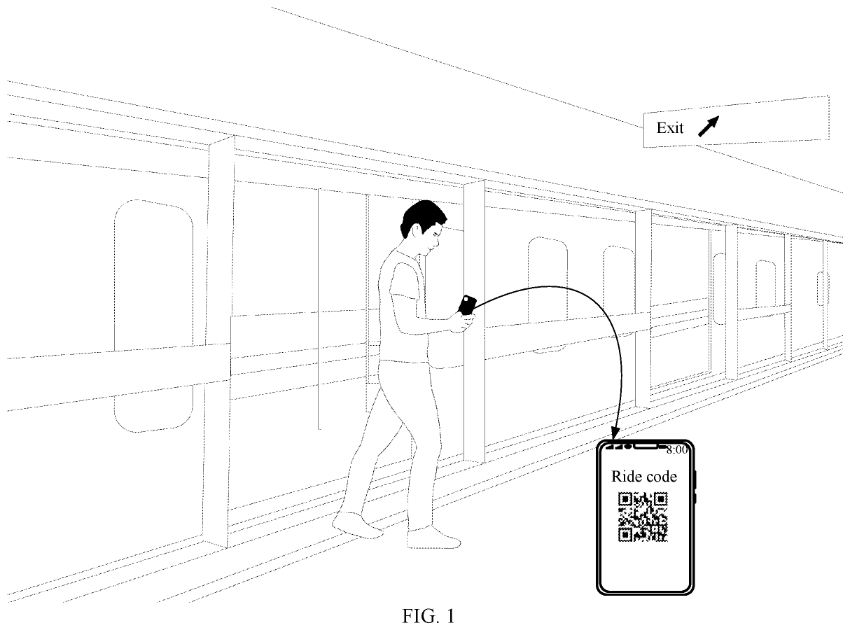

In a metro travel scenario shown in FIG. 1, the user may enable the arrival ride code push function before metro travel. For example, the user opens a setting interface of the electronic device, finds a “arrival ride code push” setting option from the setting interface, and enables the “arrival ride code push” setting option. In this way, the electronic device enables the arrival ride code push function. During travelling, the electronic device may identify a user's way of travelling, and may further identify whether the user takes a metro. When identifying that the user travels by a metro, the electronic device may push a metro ride code after detecting that the metro arrives at a station.

In an example, the electronic device may obtain a speed and location information, identify a user's way of travelling based on the speed and the location information, and may further identify whether the riding tool is a metro or not based on the speed and the location information. For example, when a category of the riding tool is a metro, the location information is location information related to a metro station, and a speed of the metro is different from that of another riding tool. Therefore, the electronic device may identify that a category of the riding tool is a metro on the basis that the speed matches the speed of the metro, and the location information is location information related to the metro station. When identifying that the category of the riding tool is a metro, the electronic device may detect whether the metro arrives at a station, and may push a metro ride code if it is detected that the metro arrives at the station. The speed of the metro may include: an acceleration, a deceleration, and a speed of the metro in a stable state, where the stable state means that the metro is in a state of a uniform speed or close to a uniform speed.

However, the electronic device may identify a single metro travel scenario based on the speed and the location information, but scenarios of a high-speed railway, a bus, a car, and the like are not identified, that is, an identification function is single, and riding tools such as a metro, a high-speed railway, a bus, and a car are not distinguished. In addition, a bus ride code can be used on the bus. Since the bus is not identified, the bus ride code cannot be pushed after the bus arrives at a station.

In view of the foregoing problems, this application provides a riding tool identification method, to identify, based on an acceleration signal, a base station signal, and a magnetometer signal, that riding tools are a metro, a high-speed railway, a bus&car (where & indicates that the bus and the car are not distinguished), and an unknown category. The “unknown category” indicates that a category of the riding tool is not identified or a way of travelling other than riding the metro, the high-speed railway, the bus, and the car is identified. For example, one of ways of travelling such as cycling, walking, and running is identified. A metro and a bus are identified based on voice signals (for example, a vehicle arrival broadcast) during ride. In this way, a metro, a high-speed railway, a bus, a car, and an unknown category are identified based on the acceleration signal, the base station signal, the magnetometer signal, and the voice signal, so that the identification function is improved, and a category of the riding tool during user travelling can be identified, for example, a metro, a high-speed railway, a bus, and a car are distinguished. In addition, the electronic device can identify ride of a bus, and can push a bus ride code after the bus arrives at the station, to improve accuracy and timeliness of pushing a ride code, thereby improving user experience.

Further, the riding tool identification method may further include: detecting a riding state, and identifying, in a case that a riding state is detected, a category of the riding tool based on the acceleration signal, the base station signal, the magnetometer signal, and the voice signal; and continuing to detect a riding state if a non-riding state is detected. In this way, the identification function is further improved, and a category of the riding tool is identified in the riding state, so that identification of a category of the riding tool in the non-riding state is omitted, thereby reducing power consumption. In an example, the riding state is detected based on the acceleration signal and the base station signal.

In this embodiment, the riding tool identification method is applicable to an electronic device. In some embodiments, the electronic device may be a mobile phone, a tablet computer, a desktop computer, a laptop computer, a notebook computer, an ultra-mobile personal computer (Ultra-mobile Personal Computer, UMPC), a handheld computer, a netbook, a personal digital assistant (Personal Digital Assistant, PDA), a wearable electronic device, a smart watch, or the like. A specific form of the electronic device is not limited in this embodiment of this application.

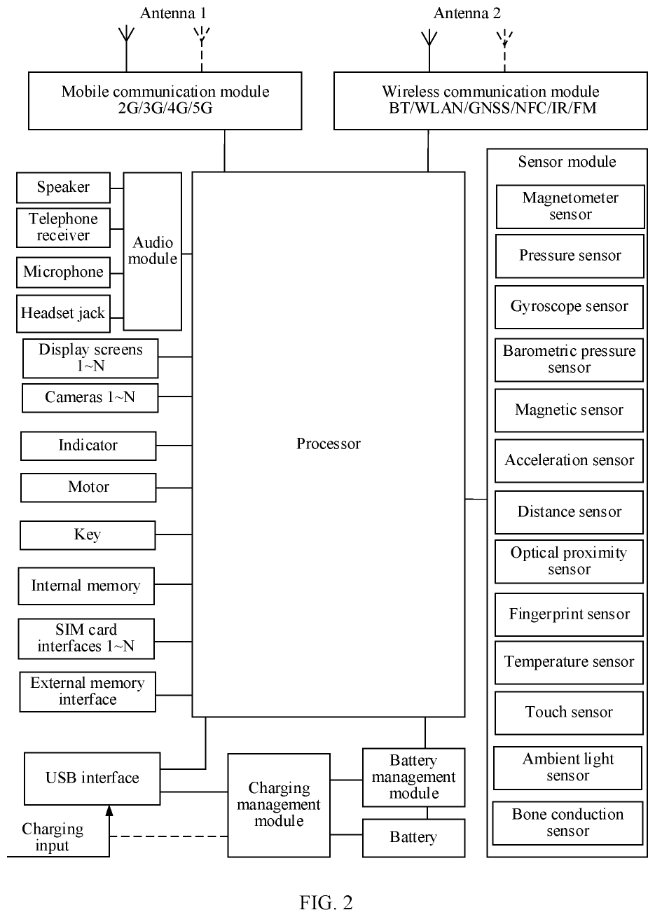

As shown in FIG. 2, the electronic device may include a processor, an external memory interface, an internal memory, a universal serial bus (universal serial bus, USB) interface, a charging management module, a power management module, a battery, an antenna 1, an antenna 2, a mobile communication module, a wireless communication module, a sensor module, a key, a motor, an indicator, a camera, a display screen, a subscriber identification module (subscriber identification module, SIM) card interface, and the like. An audio module may include a speaker, a phone receiver, a microphone, a headset jack, and the like. The sensor module may include a pressure sensor, a gyro sensor, a barometric pressure sensor, a magnetic sensor, an acceleration sensor, a distance sensor, an optical proximity sensor, a fingerprint sensor, a temperature sensor, and a touch sensor, an ambient light sensor, a bone conduction sensor, a magnetometer sensor, and the like.

It may be understood that the schematic structure in this embodiment constitutes no specific limitation on the electronic device. In some other embodiments, the electronic device may include more or fewer components than those shown in the figure, or some components may be combined, or some components may be split, or components are arranged in different manners. The components in the portrait may be implemented by hardware, software, or a combination of software and hardware.

The processor may include one or more processing units. For example, the processor may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural-network processing unit (neural-network processing unit, NPU), and the like. Different processing units may be separate devices, or may be integrated into one or more processors. The processor is a nerve center and a command center of the electronic device. The controller may generate an operation control signal according to an instruction operation code and a timing signal, to complete control of fetching and executing instructions.

The display screen is configured to display images, videos, a series of graphical user interfaces (Graphical User Interfaces, GUIs), and the like, for example, display a setting interface, a metro ride code, a bus ride code, and the like.

The external memory interface may be configured to be connected to an external storage card, for example, a micro SD card, to expand a storage capability of the electronic device. The external storage card communicates with the processor through the external memory interface, to implement a data storage function, for example, storing a file such as configuration information of a network in the external storage card. The internal memory may be configured to store computer executable program code, and the executable program code includes instructions. The processor runs the instructions stored in the internal memory, to perform various function applications and data processing of the electronic device. For example, in this application, the processor runs the instructions stored in the internal memory, so that the electronic device perform the riding tool identification method provided in this application.

The antenna 1 and the antenna 2 are configured to transmit and receive electromagnetic wave signals. Each antenna in the electronic device may be configured to cover one or more communication frequency bands. Different antennas may be multiplexed to improve antenna utilization. For example, the antenna 1 may be multiplexed into a diversity antenna of a wireless local area network. In some other embodiments, the antennas may be used with a tuning switch. The mobile communication module may provide a solution to wireless communication such as 2G/3G/4G/5G applied to the electronic device. The mobile communication module may receive an electromagnetic wave through the antenna 1, perform processing such as filtering and amplification on the received electromagnetic wave, and transmit a processed electromagnetic wave to the modem processor for demodulation. The mobile communication module may further amplify a signal modulated by the modem processor, and convert the signal into an electromagnetic wave for radiation through the antenna 1. In some embodiments, at least some functional modules of the mobile communication module may be disposed in the processor. In some embodiments, at least some functional modules of the mobile communication module and at least some modules of the processor may be disposed in the same device. For example, the modem processor may be configured in the mobile communication module. A base station signal is acquired through the modem processor.

The acceleration sensor can acquire an acceleration signal. The acceleration signal represents magnitude of accelerations in various directions (generally on three axes) of the electronic device. The magnetometer sensor can acquire a magnetometer signal. The magnetometer signal represents strength of a magnetic field where the electronic device is located, and a fluctuation of a geomagnetic amplitude can be obtained based on magnetometer signals acquired at different time points.

In addition, an operating system runs on the foregoing components, for example, an iOS operating system developed by Apple Inc., an Android open-source operating system developed by Google Inc., or a Windows operating system developed by Microsoft. An application may be installed and run on the operating system.

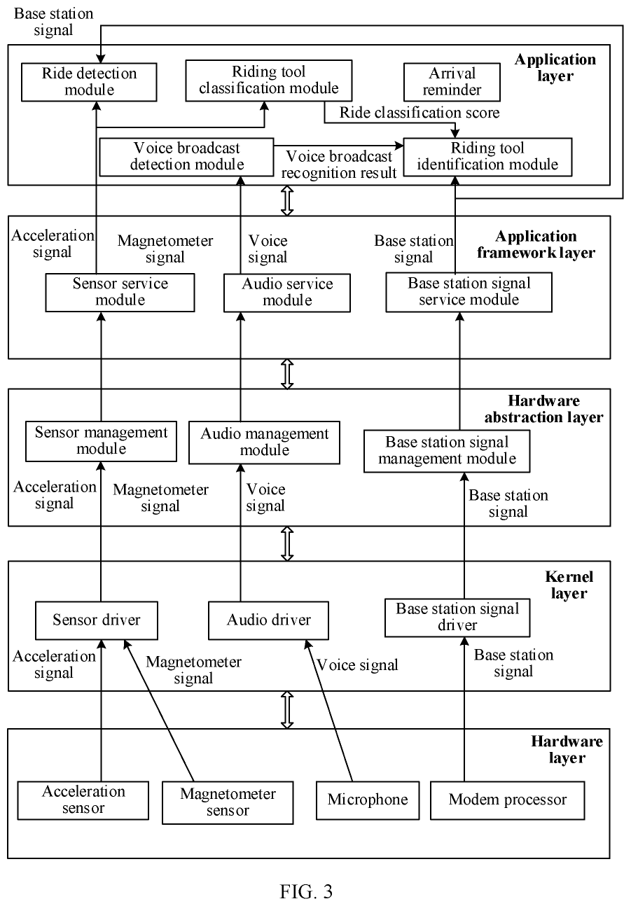

An operating system of the electronic device may use a layered architecture, an event-driven architecture, a micro core architecture, a micro service architecture, or a cloud architecture. In this embodiment of this application, the software structure of the electronic device is illustrated by using an Android system with a layered architecture as an example. FIG. 3 is a block diagram of software and hardware structures of an electronic device. The software structure uses a layered architecture. In the layered architecture, software is divided into several layers, and each layer has a clear role and task. Layers communicate with each other through software interfaces. An Android operating system is used as an example. In some embodiments, the Android system is divided into four layers: an application layer, an application framework layer (framework), a hardware abstraction layer (HAL), and a system kernel layer (kernel) from top to bottom.

The application layer may include a series of application packages. As shown in FIG. 3, the application package may include an arrival reminder APP, and the application layer may further include: a ride detection module, a riding tool classification module, a voice broadcast detection module, and a riding tool identification module. The ride detection module is configured to detect a riding state. The riding tool classification module is configured to identify a metro, a high-speed railway, a bus&car (where & indicates that the bus and the car are not distinguished), and an unknown category. The voice broadcast detection module is configured to identify a metro and a bus. The riding tool identification module is configured to identify a metro, a high-speed railway, a bus, a car, and an unknown category. The ride detection module, the riding tool classification module, the voice broadcast detection module, and the riding tool identification module may alternatively be configured at the kernel layer. The modules occupy memory capacity of the kernel layer, which may reduce a response speed of the electronic device. The ride detection module, the riding tool classification module, the voice broadcast detection module, and the riding tool identification module may alternatively be configured at the application framework layer.

The application framework layer provides an application programming interface (application programming interface, API) and a programming framework for an application at the application layer. The application framework layer includes some predefined functions. As shown in FIG. 3, the application framework layer may include a sensor service module, an audio service module, a base station signal service module.

The hardware abstraction layer may include a plurality of functional modules, for example, a sensor management module (sensor HAL), an audio management module, a base station signal management module, and the like. The kernel layer is a layer between hardware and software. The kernel layer includes at least a base station signal driver, an audio driver, and a sensor driver.

The modem processor acquires a base station signal. The base station signal is transmitted to the ride detection module and the riding tool identification module through the base station signal driver, the base station signal management module, and the base station signal service module in sequence. The microphone acquires a voice signal. The voice signal is transmitted to the voice broadcast detection module through the audio driver, the audio management module, and the audio service module in sequence. The acceleration sensor acquires an acceleration signal. The acceleration signal is transmitted to the ride detection module and the riding tool classification module through the sensor driver, the sensor management module, and the sensor service module in sequence. The magnetometer sensor acquires a magnetometer signal. The magnetometer signal is transmitted to the riding tool classification module through the sensor driver, the sensor management module, and the sensor service module in sequence.

In this embodiment, the ride detection module, the riding tool classification module, the voice broadcast detection module, and the riding tool identification module are packaged into an APP, and the APP is invoked by another APP at the application layer. The ride detection module, the riding tool classification module, the voice broadcast detection module, and the riding tool identification module are configured to be in an invisible state on a home screen. For example, the arrival reminder APP at the application layer may invoke the ride detection module, the riding tool classification module, the voice broadcast detection module, and the riding tool identification module. The ride detection module acquires an acceleration signal and a base station signal, and identifies whether being in a riding state based on the acceleration signal and the base station signal.

A detection result of the ride detection module is obtained by the riding tool classification module. When the detection result is being in a riding state, the riding tool classification module may acquire an acceleration signal and a magnetometer signal, and may obtain scores of different riding tools based on the acceleration signal and the magnetometer signal. Scores of different riding tools may include: a metro score (a score indicating that the riding tool is a metro), a high-speed railway score (a score indicating that the riding tool is a high-speed railway), a bus&car score (where & indicates that the bus and the car are not distinguished, and the score indicates that the riding tool is a bus&car), and an unknown category score (a score indicating that a category of the riding tool is not determined).

The voice broadcast detection module may acquire a voice signal, detect whether there is a voice broadcast based on the voice signal, and determine whether it is a metro voice broadcast or a bus voice broadcast if there is a voice broadcast, or determine, if there is no voice broadcast, that the voice broadcast is not detected. Identification results of the riding tool classification module and the voice broadcast detection module are sent to the riding tool identification module, and the riding tool identification module identifies, based on the identification results of the riding tool classification module and the voice broadcast detection module, that riding tools are a metro, a high-speed railway, a bus, a car, and an unknown category.

The riding tool identification method applied to the software and hardware frameworks is described in detail below.

### Embodiment 1

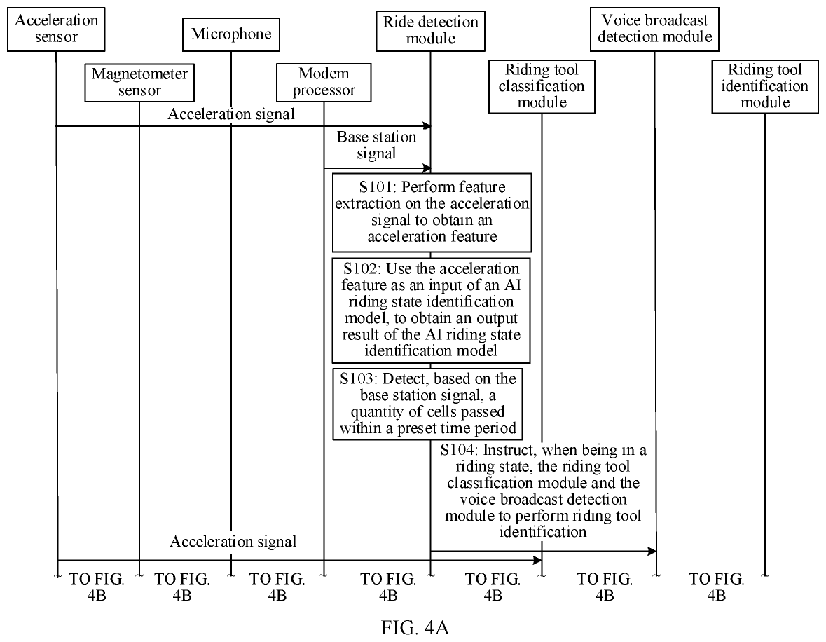

In the riding tool identification method, a plurality of sensor signals, a base station signal, and a voice signal may be fused, and riding tool identification is performed through a plurality of modules related to riding tool identification. The plurality of sensor signals include an acceleration signal and a magnetometer signal. The acceleration signal may be acquired by the acceleration sensor, the magnetometer signal may be acquired by the magnetometer sensor, the base station signal may be acquired by the modem processor, and the voice signal may be acquired by the microphone. Then, riding tools are identified by the ride detection module, the riding tool classification module, the voice broadcast detection module, and the riding tool identification module. For the process, refer to FIG. 4A to FIG. 4C. The process may include the following steps:

S101: The ride detection module performs feature extraction on an acceleration signal to obtain an acceleration feature. The acceleration feature may be an acceleration value, which may be multidimensional data extracted from sampling values of 100 HZ (hertz) of x, y, and z axes of the acceleration signal, for example, data of three axes on a plurality of dimensions such as a mean value, a peak value, and Fourier transform.

S102: The ride detection module uses the acceleration feature as an input of an artificial intelligence (Artificial Intelligence, AI) riding state identification model, to obtain an output result of the AI riding state identification model, where the output result of the AI riding state identification model may indicate whether being in a riding state. In an example, the output result of the AI riding state identification model may be a sign of whether being in a riding state. For example, the AI riding state identification model may output one of 0 and 1, where 0 indicates being in a non-riding state, and 1 indicates being in a riding state. For example, the AI riding state identification model may be a binary classification network model. An output result of the binary classification network model may be one of 0 and 1, where 0 indicates being in a non-riding state, and 1 indicates being in a riding state.

The AI riding state identification model may be configured in the ride detection module or may be independent of the ride detection module. During riding state identification, the ride detection module may invoke the AI riding state identification model. The AI riding state identification model may be obtained through training by the electronic device, or may be obtained through training by another electronic device. After being obtained through training by the another electronic device, the AI riding state identification model is provided to a ride detection module of an electronic device for use. The AI riding state identification model may be obtained by training based on at least one of a decision tree, a support vector machine (support vector machine, SVM), logistic regression, and a neural network. In a process of training the AI riding state identification model by the electronic device, the electronic device may extract a historical acceleration feature from acceleration signals during historical ride, and train the AI riding state identification model based on the historical acceleration feature.

For example, the electronic device may extract a historical acceleration value from the acceleration signals during historical ride, and train the AI riding state identification model based on the historical acceleration value and an Adaptive Boost (Adaptive Boost, AdaBoost) algorithm. The AI riding state identification model may learn an acceleration change in a riding state, so that a mapping relationship between the riding state and the acceleration change is obtained. The acceleration signals during historical ride may include acceleration signals of riding a metro, a high-speed railway, a bus, and a car, so that differences in changes of accelerations of different riding tools are considered to improve accuracy of the AI riding state identification model.

After the AI riding state identification model is trained, the ride detection module may invoke the trained AI riding state identification model, and input an extracted acceleration feature into the AI riding state identification model. The AI riding state identification model identifies a riding state based on learned acceleration changes in a riding state and acceleration changes reflected by the currently inputted acceleration feature, and outputs a sign that can indicate whether being in a riding state.

The electronic device may further extract a historical acceleration feature from acceleration signals when there is no historical ride, and train the AI riding state identification model based on the acceleration feature during historical ride and the acceleration feature when there is no historical ride. The acceleration signal when there is no ride may be an acceleration signal when the user is waking, cycling, or running, so that acceleration changes in more scenarios are introduced to improve the accuracy of the AI riding state identification model. The acceleration signal when there is no ride may be obtained in the following manners.

In a manner, the acceleration signal is acquired by a wearable device worn by the user. In another manner, an acceleration signal of a device such as a mobile phone carried by the user is considered as the acceleration signal of the user. In still another manner, the acceleration signal is simulated by the electronic device. For example, simulation is performed with reference to the acceleration signal during ride, to obtain an acceleration signal different from the acceleration signal during ride, and the different acceleration signal is used as the acceleration signal when there is no ride.

S103: The ride detection module detects, based on the base station signal, a quantity of cells passed within a preset time period.

The base station signal includes a cell identifier, and different cells have different cell identifiers. When the electronic device is handed over from one cell to another cell, the cell identifier included in the base station signal changes. Based on the change of the cell identifier, it may be determined that the electronic device is handed over from one cell to another cell, and the electronic device passes by two cells. In this way, the ride detection module may detect a quantity of changes of the cell identifier within the preset time period, and obtain, based on the quantity of changes of the cell identifier, the quantity of cells passed within the preset time period.

For example, within the preset time period, the cell identifier changes from cell 1 to cell 2, and then changes from cell 2 to cell 3. The cell identifier changes twice and passes by three cells. Based on this, the ride detection module detects that the quantity of changes of the cell identifier is N, and the quantity of cells passed is (N+1).

In this embodiment, steps S101-S102 and step S103 may be performed in parallel. Alternatively, step S103 may be first performed, and then steps S101-S102 are performed. A sequence of steps S101-S102 and step S103 is not limited in this embodiment.

S104: The ride detection module instructs, when the ride detection module determines being in a riding state based on the quantity of cells and an output result of the AI riding state identification model indicates being in a riding state, the riding tool classification module and the voice broadcast detection module to perform riding tool identification.

The ride detection module determines being in a riding state if the quantity of cells passed by the electronic device within the preset time period is greater than a preset quantity of cells. Generally, a speed of the user when walking, cycling, or running is less than a speed during ride. Correspondingly, within a time period, a movement distance of the user when walking, cycling, or running is less than a movement distance during ride. A larger movement distance may indicate a larger quantity of times of cell handover in the electronic device, and indicate a larger quantity of cells passed by the electronic device within a time period. Based on this, the ride detection module may set a preset quantity of cells, and the preset quantity of cells represents a quantity of cells passed within the preset time period when the user may not ride. By comparing with the preset quantity of cells, whether being in a riding state is determined.

In an example, the ride detection module may collect statistics on a quantity of cells passed in a non-riding state within the preset time period, and the preset quantity of cells is obtained based on the quantity of cells passed in the non-riding state within the preset time period. For example, the ride detection module may collect statistics on a quantity of cells passed by the user within a preset time period when walking, cycling, and running, and a maximum quantity of cells in the collected quantities of cells is used as the preset quantity of cells, or the preset quantity of cells is obtained based on at least a part of all the collected quantities of cells, where the at least a part may be a quantity of cells with a middle value, excluding extreme cases such as a minimum quantity of cells and the maximum quantity of cells.

In an example, the ride detection module may collect statistics on a quantity of cells passed in a riding state within the preset time period, and the preset quantity of cells is obtained based on the quantity of cells passed in the riding state within the preset time period. For example, the ride detection module may collect statistics on a quantity of cells passed within a preset time period when the user rides a metro, a bus, a car, and the like, and a minimum quantity of cells in the collected quantities of cells is used as a preset quantity of cells, or the preset quantity of cells is obtained based on at least a part of all the collected quantities of cells. Details are not described herein again.

In this embodiment, the ride detection module may be manually triggered by the user to determine the preset quantity of cells. For example, when the user is walking, cycling, and running, the user enables the ride detection module, and the ride detection module may collect statistics on a quantity of cells passed to obtain the preset quantity of cells. In addition, the preset time period may be a time parameter used for identifying a riding state. The preset time period may be set to a smaller value to distinguish between scenarios of walking, cycling, running and riding. However, to improve the accuracy, a value of the preset time period may not be too small. For example, the preset time period may be in a range of [3 minutes, 5 minutes], a time point is selected from [3 minutes, 5 minutes], and the value of the preset time period is not limited in this embodiment.

An output of the ride detection module may be used as an interface, and the riding tool classification module and the voice broadcast detection module may invoke the interface, to obtain a detection result of the ride detection module. When the detection result is being in a riding state, the riding tool classification module and the voice broadcast detection module may identify and classify riding tools, to identify a category of the riding tool.

When the ride detection module determines being in a non-riding state based on the quantity of cells and/or the output result of the AI riding state identification model indicates being in a non-riding state, the ride detection module continues to obtain an acceleration signal and a base station signal.

S105: The riding tool classification module performs feature extraction on the acceleration signal and the magnetometer signal, to obtain an acceleration feature and a magnetometer feature. The magnetometer feature may be a geomagnetic amplitude, or may be data on a plurality of dimensions such as a mean value, a peak value, and Fourier transform that is extracted from the magnetometer signal.

S106: The riding tool classification module uses the acceleration feature and the magnetometer feature as inputs of the AI riding classification model, to obtain an output result of the AI riding classification model, where the output result of the AI riding classification model is scores of a riding tool, namely, a metro, a high-speed railway, a bus&car, and an unknown category, which is referred to as a ride classification score for short, and the ride classification score is denoted as P (metro), P (high-speed railway), P (bus/car), and P (unknown). For example, the AI riding classification model may be a four-classification network model. The four-classification network model may output a ride classification score.

The AI riding classification model may be configured in the riding tool classification module, or may be independent of the riding tool classification module. During riding tool identification, the riding tool classification module may invoke the AI riding classification model. The AI riding classification model may be obtained through training by the electronic device, or may be obtained through training by another electronic device. After being obtained through training by the another electronic device, the AI riding state identification model is provided to a riding tool classification module of an electronic device for use. The AI riding classification model may be obtained by training based on at least one of a decision tree, an SVM, logistic regression, and a neural network.

In a process of training the AI riding classification model, the electronic device may extract a historical acceleration feature from acceleration signals during historical ride, and extract a historical magnetometer feature from magnetometer signals during historical ride. The historical acceleration feature can reflect acceleration changes during ride, and the historical magnetometer feature can reflect fluctuations of a geomagnetic amplitude during ride. The historical ride may include riding a metro, a high-speed railway, a bus, and a car, so that historical acceleration features and historical magnetometer features of different riding tools are obtained, and the AI riding classification model is trained based on the historical acceleration features and the historical magnetometer features.

For example, the historical acceleration feature may be a historical acceleration value, and the historical magnetometer feature may be a historical geomagnetic amplitude. The electronic device can train the AI riding classification model based on the historical acceleration value, the historical geomagnetic amplitude, and the AdaBoost algorithm. The AI riding classification model may learn acceleration changes and geomagnetic fluctuations of different riding tools. For example, the AI riding classification model may establish relationships between different riding tools and acceleration changes and geomagnetic fluctuations.

After the AI riding classification model is trained, the riding tool classification module invokes the trained AI riding classification model to input a currently extracted acceleration feature and magnetometer feature into the AI riding classification model. The AI riding classification model may output scores of different riding tools based on the learned acceleration changes and geomagnetic fluctuations of different riding tools, an acceleration change reflected by the currently extracted acceleration feature and a geomagnetic fluctuation reflected by the magnetometer feature, that is, the AI riding classification model may output four scores, namely, P (metro), P (high-speed railway), P (bus/car), and P (unknown). P (metro), P (high-speed railway), P (bus/car), and P (unknown) may be probability values, for example, P (metro) indicates a probability that the riding tool is a metro.

In addition, the electronic device may further extract a historical acceleration feature and a historical magnetometer feature when there is no ride from an acceleration signal and a magnetometer signal when there is no historical ride, and train the AI riding classification model based on the historical acceleration feature and the historical magnetometer feature during ride, and the historical acceleration feature and the historical magnetometer feature when there is no ride, so that differences between acceleration changes and geomagnetic fluctuations in different scenarios are considered, to improve the accuracy of the AI riding classification model.

In this embodiment, the riding tool classification module may introduce the magnetometer feature, to facilitate in distinguishing between riding tools of different categories through the magnetometer feature. This is because, during start and stop of a metro, a geomagnetic amplitude may greatly fluctuate due to electromagnetic induction. During start and stop of a high-speed railway, a geomagnetic amplitude fluctuates due to electromagnetic induction, but the fluctuation of the geomagnetic amplitude of the high-speed railway is less than the fluctuation of the geomagnetic amplitude of the metro. During start and stop of a bus and a car, geomagnetic amplitudes may also fluctuate. Since there is no electromagnetic induction or electromagnetic induction is weak, fluctuations of geomagnetic amplitudes of the bus and the car are less than the fluctuation of the geomagnetic amplitude of the high-speed railway. Therefore, the magnetometer feature reflecting a fluctuation of a geomagnetic amplitude is introduced into identification of a category of the riding tool, to effectively distinguish between riding tools, thereby improving the accuracy of identifying a category of the riding tool.

S107: The voice broadcast detection module pre-processes the voice signal, to eliminate influence of noise on the voice signal and determine that the voice signal is not a noise signal. If the voice signal is determined as a noise signal, the voice broadcast detection module may continue to obtain a voice signal. For example, the voice broadcast detection module performs voice detection on the voice signal, to detect that there is a sound in an environment where the electronic device is located and that the sound is not noise.

The voice signal may be acquired by a microphone of the electronic device, and the voice signal acquired by the microphone is sent to the voice broadcast detection module for identification and processing. However, if the electronic device keeps the microphone in an on-state for a long time, resources may be wasted and power consumption may be increased. Based on this, the electronic device may control an operating status of the microphone.

In a control method, if the ride detection module detects being in a riding state, the microphone is controlled to be turned on; and if the ride detection module detects being in a non-riding state or changing from a riding state to a non-riding state, the microphone is controlled to be turned off. The microphone may intermittently or periodically acquire a voice signal within a time period from when the microphone is turned on to when the microphone is turned off.

In another control method, after enabling an arrival ride code push function, the electronic device controls the microphone to be turned on; and after completing push of a ride code, the electronic device controls the microphone to be turned off. After pushing the ride code once and controlling the microphone to be turned off, the electronic device may control, based on a rule, the microphone to be turned on again. For example, the electronic device may control the microphone to be turned on again at an interval of time. In another example, the electronic device may obtain location information. If the location information indicates that there is possibility of taking a ride (such as along a traffic line), and the electronic device controls the microphone to be turned on again.

In this embodiment, the electronic device may control the microphone in combination with modules used for the arrival ride code push function and riding tool category identification. For example, the arrival ride code push function is combined with the ride detection module, and after the electronic device enables the arrival ride code push function, the microphone is controlled to be turned on; and if the ride detection module detects a non-riding state, the microphone is controlled to be turned off. In another example, after enabling the arrival ride code push function, the electronic device controls the microphone to be turned on; within a time period when the microphone is in an on state, the ride detection module detects being in a non-riding state within the time period, the electronic device may turn off the microphone; and after the ride detection module detects being in a riding state, the electronic device may turn on the microphone. Certainly, the electronic device may further turn off the microphone after detecting use of the pushed ride code.

In another control method, if the ride detection module detects being in a riding state, the microphone is controlled to be turned on; and after the voice broadcast detection module completes recognition processing, the microphone is controlled to be turned off. It may be understood that, a result recognized by the voice broadcast detection module may be maintained until an end of a riding state, and after the voice broadcast detection module recognizes a result, the microphone is controlled to be turned off, where an off state of the microphone is maintained until an end of a riding state. For example, the ride detection module detects being in a riding state, the voice broadcast detection module detects voice and identifies a bus, a voice broadcast recognition result of the voice broadcast detection module is a bus. The voice broadcast recognition result may be recorded in a corresponding memory until the ride detection module detects being in a non-riding state (for example, drop-off of the user), and the voice broadcast recognition result of a bus in the memory is cleared. After the voice broadcast detection module recognizes a bus, the microphone is turned off, and the microphone is in an off state within a time period from when the voice broadcast detection module recognizes a bus to when the ride detection module detects being a non-riding state. When the ride detection module detects being in a riding state again, the microphone is turned on, and the voice broadcast detection module performs voice recognition again.

It may be understood that, during a ride, a voice playback detection module may control the microphone to be turned on, and voice signals are acquired for a plurality of times, to perform voice recognition for a plurality of times. Based on this, a memory in the electronic device may store voice broadcast recognition results of the voice playback detection module, a voice broadcast recognition result detected each time may replace a previous voice broadcast recognition result and be stored in the memory, and the voice broadcast recognition result in the memory is cleared when the ride ends. For example, during a ride, the voice broadcast detection module may intermittently or periodically control the microphone to be turned on.

In addition, the electronic device may further control the microphone according to an operating status of the electronic device. For example, when the electronic device is in a screen-on state, the microphone is controlled to be turned on; and when the electronic device is in a screen-off state, the microphone is controlled to be turned off. In another example, when the electronic device is locked, the microphone is controlled to be turned off; and when the electronic device is unlocked, the microphone is controlled to be turned on. The control based on the operating status of the electronic device may be combined with the foregoing manner, which is not described in detail in this embodiment.

S108: The voice broadcast detection module performs feature extraction on the pre-processed voice signal, to obtain a Mel-frequency cepstral coefficient (Mel-Frequency Cepstral Coefficient, MFCC) feature.

S109: The voice broadcast detection module uses the MFCC feature as an input of the AI voice type recognition model to obtain an output result of the AI voice type recognition model, where the output result of the AI voice type recognition model may be a voice broadcast recognition result, and the voice broadcast recognition result is one of a metro voice broadcast, a bus voice broadcast, and being not detected.

The metro and the bus may perform voice broadcast during driving. The voice broadcast may be pre-recorded human voice, and the human voice may be voice of a real person or a virtual person. In other words, the voice broadcast may correspond to a metro broadcaster or a bus broadcaster, and an MFCC feature during voice broadcast may reflect a voiceprint characteristic of a broadcaster. Based on this, the AI voice type recognition model in this embodiment may learn voiceprint characteristics of different broadcasters, to establish a mapping relationship between a voiceprint characteristic reflected by a voice feature and a broadcaster. After a voice broadcast detection module inputs a currently extracted MFCC feature into the AI voice type recognition model, the AI voice type recognition model may identify a voiceprint feature reflected by the MFCC feature. Based on whether the voiceprint feature corresponds to a metro broadcaster or a bus broadcaster, or that the voiceprint feature is not detected, a voice signal may be introduced, so that accuracy of identifying a metro and a bus is improved, and a bus and a car can be distinguished.

The AI voice type recognition model may be configured in the voice broadcast detection module, or may be independent of the voice broadcast detection module. During riding tool identification, the voice broadcast detection module may invoke the AI voice type recognition model. The AI voice type recognition model may be obtained through training by the electronic device, or may be obtained through training by another electronic device. After being obtained through training by the another electronic device, the AI riding state identification model is provided to a voice broadcast detection module of an electronic device for use. In this embodiment, the AI voice type recognition model may be obtained by training based on a convolutional neural network, for example, may be obtained by training based on at least one of a deep residual network (Deep Residual Network, ResNet), a deep convolutional neural network (VGG), and a lightweight deep neural network (MobileNet).

The electronic device may obtain voice signals of metro arrival and bus arrival in advance. Since voice broadcasts in different cities may be different, the electronic device may obtain voice signals of metro arrival and bus arrival of different cities in advance. The electronic device performs feature recognition on each voice signal obtained in advance, to obtain an MFCC feature of each voice signal, and trains the AI voice type recognition model based on the MFCC feature of the voice signal. For example, the electronic device may train the AI voice type recognition model based on the MFCC feature of the voice signal and MobileNet.

The MFCC feature is a relatively prominent feature in voiceprint recognition. Riding tool category identification based on the MFCC feature and the AI voice type recognition model is merely an example. The voice broadcast detection module may perform riding tool category identification based on other voice features and the AI voice type recognition model, and details are not described herein again.

In this embodiment, the voice broadcast detection module and the riding tool classification module may run in parallel. Alternatively, one of the voice broadcast detection module and the riding tool classification module runs first, and the other module runs later. A sequence of the two models is not limited in this embodiment. Recognition results of the voice broadcast detection module and the riding tool classification module are sent to the riding tool identification module for processing. For example, the riding tool classification module sends a ride classification score to the riding tool identification module, and the voice broadcast detection module sends a voice broadcast recognition result to the riding tool identification module.

S110: The riding tool identification module determines that the riding tool is a high-speed railway if P (high-speed railway) is the largest in the ride classification scores, P (high-speed railway) is greater than a first threshold, and the base station signal includes a high-speed railway identifier.

S111: The riding tool identification module determine that the riding tool is a metro if P (metro) is the largest in the ride classification scores, and P (metro) is greater than a second threshold, or the riding tool identification module determines that the riding tool is a metro if P (metro) is greater than a third threshold, and the voice broadcast detection module detects metro arrival broadcast voice, where the third threshold may be less than the second threshold, the second threshold and the first threshold may be the same or different.

S112: The riding tool identification module determines that the riding tool is a bus if P (bus/car) in the ride classification scores is greater than a fourth threshold, and the voice broadcast detection module detects bus arrival broadcast voice.

S113: The riding tool identification module determines that the riding tool is a car if P (bus/car) is the largest in the ride classification scores, P (bus/car) is greater than a fifth threshold, and the voice broadcast detection module does not detect the bus arrival broadcast voice, where the fifth threshold, the fourth threshold, the second threshold, and the first threshold may be the same or different, or may be partially the same.

In the process of distinguishing between a bus and a car by using bus arrival broadcast voice, the riding tool identification module may add a time limitation in a determination condition. In a manner, if P (bus/car) in the ride classification scores is greater than the fourth threshold, and the voice broadcast detection module detects bus arrival broadcast voice within a first preset duration, the riding tool identification module determines that the riding tool is a bus. It P (bus/car) is the largest in the ride classification scores, P (bus/car) is greater than the fifth threshold, and the voice broadcast detection module does not detect bus arrival broadcast voice within a second preset duration, the riding tool identification module determines that the riding tool is a car, where the second preset duration may be longer than the first preset duration, that is, the second preset duration is selected as a longer time period, and a case in which a distance between bus stations is relatively long is excluded, and there is no bus broadcast voice for a relatively long time, thereby improving the accuracy.

S114: The riding tool identification module determines that the riding tool is an unknown category in other situations other than step S110 to step S113.

In the riding tool identification method shown in FIG. 4A to FIG. 4C, the plurality sensor signals, the base station signal, and the voice signal are fused to perform riding tool identification. A high-speed railway and a metro may be effectively distinguished based on the magnetometer signal, a bus and a car may be effectively distinguished based on the voice signal, and a metro and a bus may be further distinguished based on the voice signal, so that accuracy of the metro and the bus is improved. In addition, a high-speed railway signal is distinguished based on the base station signal, so that accuracy of the high-speed railway is improved. In this way, the riding tool identification method can effectively distinguish between riding tools of different categories, thereby improving the accuracy of identifying a riding tool.

In addition, the output result of the AI voice type recognition model may be a broadcast result score, where the broadcast result score includes scores of three states, namely, P (metro voice broadcast), P (bus voice broadcast), and P (not detected). The broadcast result score may be a probability value, for example, P (a metro voice broadcast) indicates that a probability that the voice signal belongs to the metro voice broadcast.

The voice broadcast detection module may send a broadcast result score to the riding tool identification module. The riding tool identification module determines one result of a metro voice broadcast, a bus voice broadcast, and being not detected based on comparison between the broadcast result score and a threshold. The riding tool identification module may respectively set a threshold for a metro, a bus, and being not detected. If P (metro voice broadcast) is greater than a threshold of the metro, the metro voice broadcast is determined.

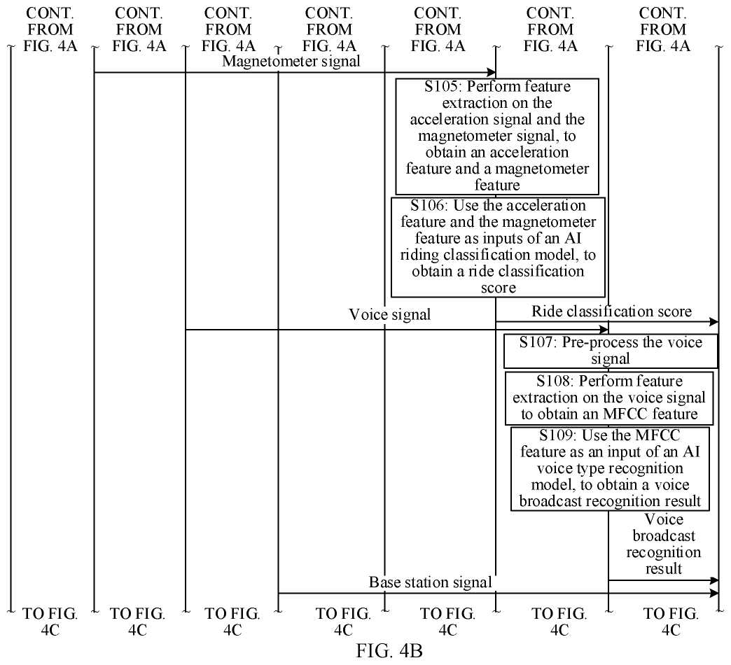

Using an example in which the electronic device is a mobile phone, a description in which the riding tool identification method is performed on the mobile phone is made below. As shown in FIG. 5, a hardware device in the mobile phone acquires a base station signal, an acceleration signal, a magnetometer signal, and a voice signal. The ride detection module detects a riding state based on the base station signal and the magnetometer signal, to determine whether being in a riding state. If being in a riding state is determined, the riding tool classification module may obtain a ride classification score based on the acceleration signal and the magnetometer signal. Correspondingly, the voice broadcast detection module may detect a voice broadcast based on the voice signal. The riding tool classification module, the voice broadcast detection module, and the riding tool identification module may be enabled after being in a riding state is determined, and are disabled after identification and detection is completed. The riding tool identification module may identify a category of the riding tool based on an identification result of the riding tool classification module (for example, a riding tool score), an identification result of the voice broadcast detection module (for example, a broadcast result score), and a base station signal. That identification and detection is completed may be to complete identification on a category of the riding tool once. If the ride detection module detects being in a riding state again, the riding tool classification module, the voice broadcast detection module, and the riding tool identification module are enabled again.

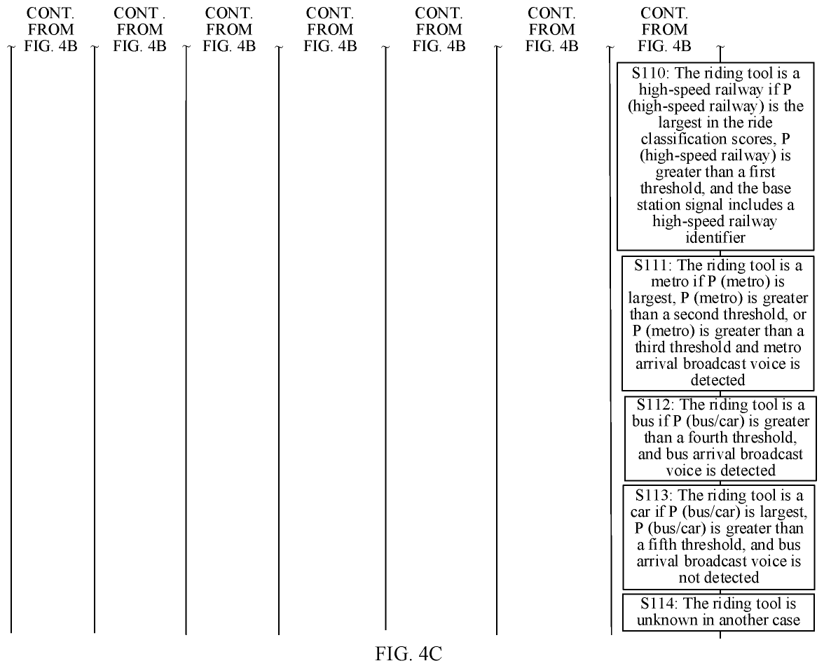

A working procedure of the ride detection module is shown in FIG. 6. The ride detection module extracts an acceleration feature from acceleration signals, and riding state identification based on the acceleration feature and the pre-trained AI riding state identification model to identify whether being in a riding state, where the AI riding state identification model may be obtained by training based on a decision tree, an SVM, logistic regression, a neural network, and the like. The ride detection module may detect, based on the base station signal, a quantity of cells passed within a preset time period. The ride detection module may determine being in a riding state if the quantity of cells is greater than a preset quantity of cells. When being in a riding state is identified respectively based on the quantity of cells and the AI riding state identification model, the ride detection module may obtain a detection result of being in a riding state. When being in a non-riding state is identified based on the quantity of cells or the AI riding state identification model, the ride detection module may obtain a detection result of being in a non-riding state.

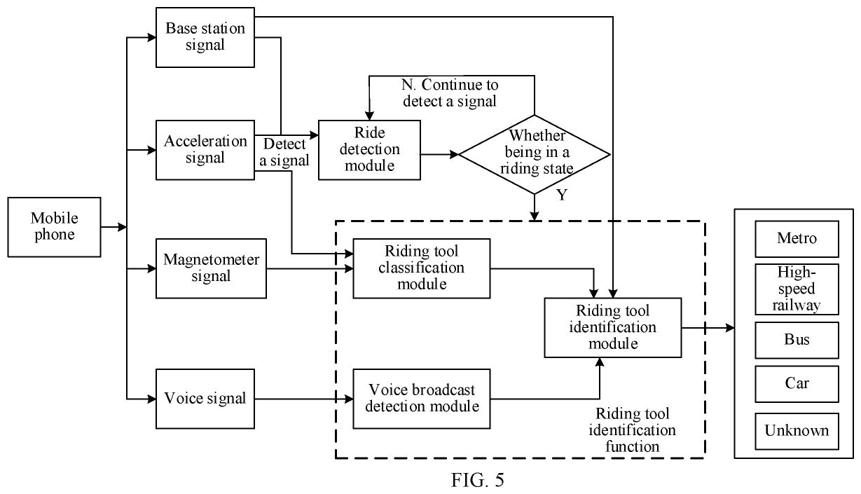

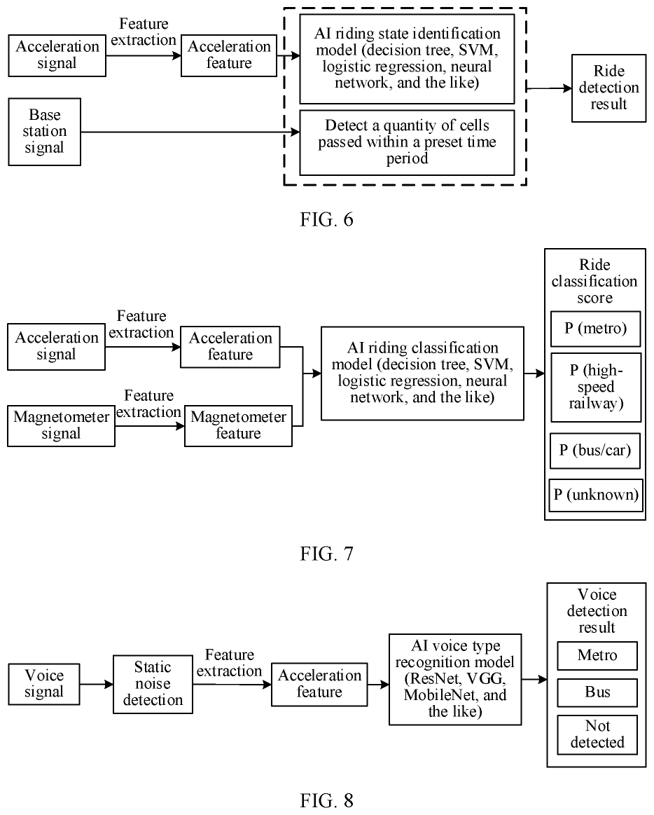

After the riding detection module obtains a detection result, the ride detection module may continue to detect a riding state. The riding tool classification module, the voice broadcast detection module, and the riding tool identification module may continuous operate, or may also determine, based on the detection result of the ride detection module, whether to operate. In a manner, after the ride detection module obtains a detection result of being in a non-riding state, the ride detection module may continue to detect the base station signal and the acceleration signal, and the riding tool classification module, the voice broadcast detection module, and the riding tool identification module do not operate. After the ride detection module obtains a detection result of being in a riding state, the riding tool classification module, the voice broadcast detection module, and the riding tool identification module operate. The process is shown in FIG. 7 and FIG. 8.

FIG. 7 shows a working procedure of the riding tool classification module when the AI riding classification model is a four-classification network model. The riding tool classification module extracts an acceleration feature from acceleration signals, and extracts a magnetometer feature from magnetometer signals. Then, the riding tool classification module obtains ride classification scores based on the acceleration feature, the magnetometer feature, and a pre-trained four-classification network model. The four-classification network model may be obtained by training based on a decision tree, an SVM, logistic regression, a neural network, and the like. The ride classification scores include scores of riding tools of a metro, a high-speed railway, a bus&car, and an unknown category. The scores of four categories are denoted as P (metro), P (high-speed railway), P (bus/car), and P (unknown).

The four-classification network model is an optional model of the AI riding classification model. The AI riding classification model may be a three-classification network model. The three-classification network model may output scores of three categories, and the scores of three categories are denoted as P (metro), P (bus/car), and P (unknown). A quantity of categories that can be identified by the AI riding classification model is not limited in this embodiment.

FIG. 8 shows a working procedure of the voice broadcast detection module when the AI voice category recognition model is a three-classification network model. The voice broadcast detection module may obtain a voice signal and perform voice detection on the voice signal, to detect an ambient sound in the voice signal and detect that the voice signal is not noise. Then, the voice broadcast detection module performs feature extraction on a voice signal on which voice detection is performed, to obtain an MFCC feature. A voice broadcast recognition result is obtained based on the MFCC feature and a pre-trained three-classification network model. The three-classification network model is obtained by training based on ResNet, VGG, MobileNet, and the like. The voice broadcast recognition result may recognize one of a metro voice broadcast, a bus voice broadcast, and being not detected.

The three-classification network model is an optional model of the AI voice category recognition model. The AI voice category recognition model may be a binary classification network model. Voice broadcast recognition results outputted by the binary classification network model may be a metro voice broadcast and a bus voice broadcast. A quantity of voice results that can be recognized by the AI voice category recognition model is not limited in this embodiment.

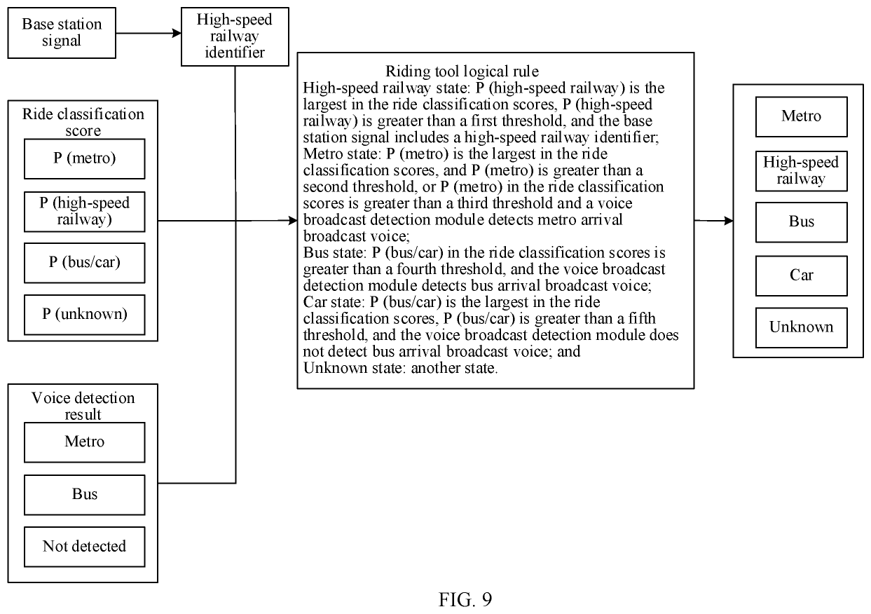

The ride classification scores obtained by the riding tool classification module are provided to the riding tool identification module, the voice broadcast recognition results obtained by the voice broadcast detection module are also provided to the riding tool identification module, and the riding tool identification module identifies a category of the riding tool. A working procedure is shown in FIG. 9. The riding tool classification module may determine based on riding tool logical rules, and the riding tool logical rules are as follow:

High-speed railway state: P (high-speed railway) is the largest in the ride classification scores, P (high-speed railway) is greater than a first threshold, and the base station signal includes a high-speed railway identifier.

Metro state: P (metro) is the largest in the ride classification scores, and P (metro) is greater than a second threshold, or P (metro) in the ride classification scores is greater than a third threshold and the voice broadcast detection module detects metro arrival broadcast voice.

Bus state: P (bus/car) in the ride classification scores is greater than a fourth threshold, and the voice broadcast detection module detects bus arrival broadcast voice.

Car state: P (bus/car) is the largest in the ride classification scores, P (bus/car) is greater than a fifth threshold, and the voice broadcast detection module does not detect bus arrival broadcast voice.

Unknown state: another state.

In combination with the foregoing riding tool logical rules, the riding tool identification module may identify a category of the riding tool based on the base station signal, the ride classification score, and the voice broadcast recognition result.

In this embodiment, the riding tool identification method may be applied to an arrival ride code push scenario. When the user rides at least one of a bus or a metro, a mobile phone carried by the user can implement the riding tool identification method. When the mobile phone identifies that the user is in a riding state, the mobile phone may obtain a ride classification score based on the acceleration signal and the magnetometer signal and obtain a voice broadcast recognition result based on the voice signal, and then the mobile phone identifies a category of a current riding tool based on the ride classification score, the voice broadcast recognition result, and the base station signal. If a category of the riding tool is a metro, the mobile phone may push a metro ride code. If a category of the riding tool is a bus, the mobile phone may push a bus ride code. If a category of the riding tool is one of a high-speed railway, a car, and an unknown category, the mobile phone does not push a ride code.

### Embodiment 2

During start and stop of a metro, a geomagnetic amplitude may greatly fluctuate due to electromagnetic induction. During start and stop of a high-speed railway, a geomagnetic amplitude fluctuates due to electromagnetic induction, but the fluctuation of the geomagnetic amplitude of the high-speed railway is less than the fluctuation of the geomagnetic amplitude of the metro. During start and stop of a bus and a car, geomagnetic amplitudes may also fluctuate. Since there is no electromagnetic induction or electromagnetic induction is weak, fluctuations of geomagnetic amplitudes of the bus and the car are less than the fluctuation of the geomagnetic amplitude of the high-speed railway. Therefore, in this embodiment, a category of the riding tool may be identified based on the fluctuation of the geomagnetic amplitude. The magnetometer feature in the magnetometer signal may reflect a geomagnetic fluctuation, and correspondingly, the riding tool classification module may identify a category of the riding tool based on the magnetometer signal.

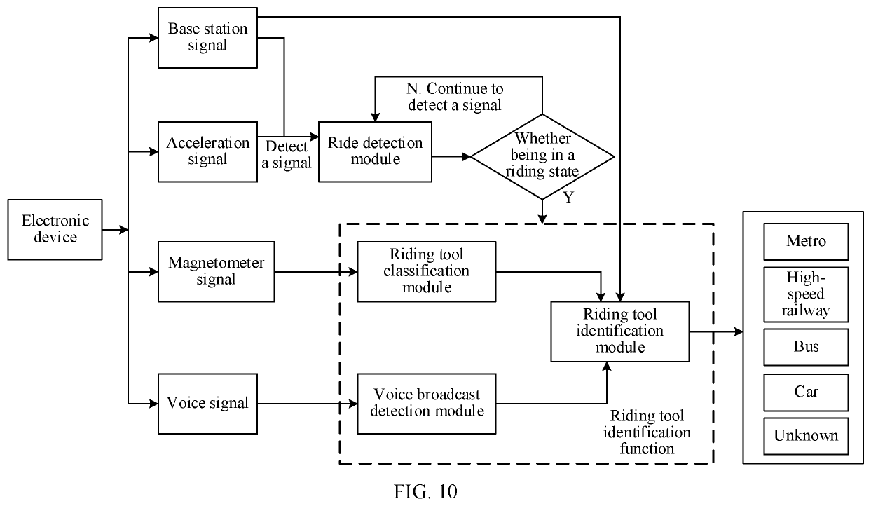

FIG. 10 shows a working procedure of the riding tool identification method. The ride detection module extracts an acceleration feature from the acceleration signal, and performs riding state identification based on the acceleration feature and the pre-trained AI riding state identification model, to identify whether being in a riding state. The riding detection module may identify a riding state based on the base station signal. When being in a riding state is determined based on the acceleration signal and the base station signal, a detection result of being in a riding state is obtained.

The riding tool classification module extracts a magnetometer feature from the magnetometer signal. Then, the riding tool classification module obtains ride classification scores based on the magnetometer feature, and a pre-trained AI riding classification model. The AI riding classification model may be obtained by training based on a decision tree, an SVM, logistic regression, a neural network, and the like. The ride classification scores include scores of riding tools of a metro, a high-speed railway, a bus&car, and an unknown category. The scores of four categories are denoted as P (metro), P (high-speed railway), P (bus/car), and P (unknown). Different from Embodiment 1, the AI riding classification model is obtained by training based on the magnetometer feature. The process is not described in detail again. The voice broadcast detection module may obtain a voice signal, and a voice broadcast recognition result is obtained based on a voice feature (for example, an MFCC feature) extracted from the voice signal and the AI voice type recognition model. The riding tool identification module may identify a category of the riding tool based on the ride classification score, the voice broadcast recognition result, and the base station signal. For example, a category of the riding tool may be identified with reference to the riding tool logical rules.

In Embodiment 1 and Embodiment 2, the accuracy may be improved in combination with the riding tool identification module and the base station signal. For example, when a category of the riding tool is a high-speed railway, the accuracy may be improved based on the base station signal. However, the riding tool identification module may also identify a category of the riding tool based on the ride classification score and the voice broadcast recognition result, so that a high-speed railway, a metro, a bus, and a car can be effectively distinguished, and the accuracy may also be improved.

### Embodiment 3

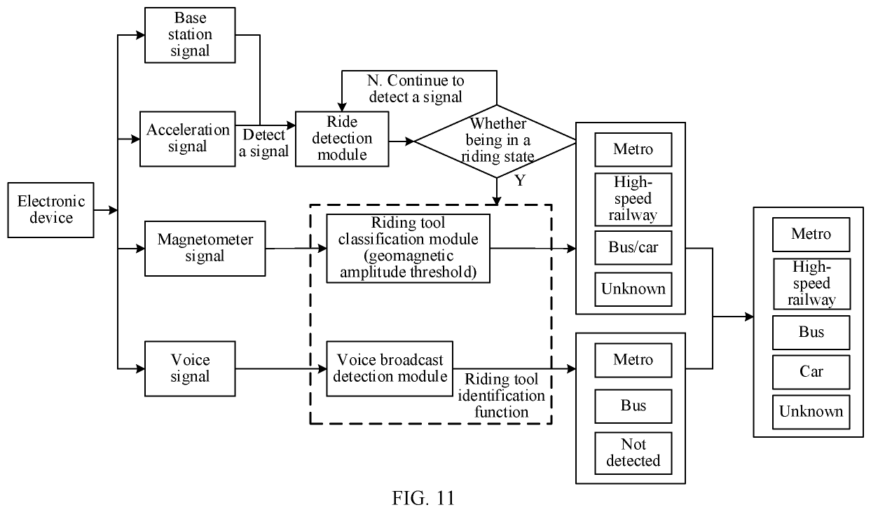

FIG. 11 shows another working procedure of the riding tool identification method. The ride detection module extracts an acceleration feature from the acceleration signal, and performs riding state identification based on the acceleration feature and the pre-trained AI riding state identification model, to identify whether being in a riding state. The riding detection module may identify a riding state based on the base station signal. When being in a riding state is determined based on the acceleration signal and the base station signal, a detection result of being in a riding state is obtained.

When the riding tool classification module performs identification based on the magnetometer signal, fluctuation data of a geomagnetic amplitude may be set for a metro, a high-speed railway, and a bus/car. For example, geomagnetic amplitude thresholds are set for the metro, the high-speed railway, and the bus/car. The geomagnetic amplitude threshold of the metro is greater than the geomagnetic amplitude threshold of the high-speed railway, and the geomagnetic amplitude threshold of the high-speed railway is greater than the geomagnetic amplitude threshold of the bus/car.

After obtaining a magnetometer signal, the riding tool classification module extracts a magnetometer feature based on the magnetometer signal, for example, a geomagnetic amplitude (a manifestation of the magnetometer feature) is obtained based on the magnetometer signal. Then, a category of the riding tool is identified based on comparison between the geomagnetic amplitude and the geomagnetic amplitude thresholds of the riding tools.

The voice broadcast detection module may obtain a voice signal, and a voice broadcast recognition result is obtained based on a voice feature (for example, an MFCC feature) extracted from the voice signal and the AI voice type recognition model, so that when the riding tool is a bus/car, the bus and the car can be distinguished based on the voice broadcast recognition result.

In this embodiment, the riding tool classification module may identify one riding tool of a high-speed railway, a metro, a bus/car, and an unknown category. When the riding tool is a bus/car, the voice broadcast detection module identifies that a current riding tool is one of a metro, a bus, and being not detected based on the voice signal, so that when the riding tool is a bus/car, the bus and the car can be distinguished based on the voice signal. In addition, when the riding tool is a metro, identification may also be performed based on the voice broadcast detection module, to improve the accuracy of the metro. The enabling of the voice broadcast detection module can identify the riding tool as a bus/car through the riding tool classification module, saving resources.

In Embodiment 1 to Embodiment 3, the voice broadcast detection module may be applied to a high-speed railway identifier. This is because the high-speed railway also broadcasts voice during driving, for example, broadcasts before arriving at a station and when arriving at a station. Voice of a high-speed railway broadcast may be different from that of a metro broadcast and a bus broadcast, and correspondingly, the AI voice type recognition model selects a four-classification network model. The electronic device may obtain voice signals of metro arrival, bus arrival, and high-speed railway arrival in advance. Since voice broadcasts in different cities may be different, the electronic device may obtain voice signals of metro arrival, bus arrival, and high-speed railway arrival in different cities in advance. The electronic device performs feature recognition on each voice signal obtained in advance, to obtain an MFCC feature of each voice signal, and trains the AI voice type recognition model based on the MFCC feature of the voice signal. For example, the electronic device may train the AI voice type recognition model based on the MFCC feature of the voice signal and MobileNet. The voice broadcast detection module may identify based on the AI voice type recognition model, to distinguish between a high-speed railway, a metro, a bus, and being not detected.

In addition to performing identification based on the AI voice type recognition model, the voice broadcast detection module may perform identification in another form. In a manner, the voice broadcast detection module may identify the riding tool as one of a high-speed railway, a metro, a bus, and an unknown category based on a broadcast frequency of a voice signal acquired by the microphone. Since a distance between high-speed railway stations is relatively long, a broadcast frequency of a high-speed railway recognized by the voice broadcast detection module is higher than a broadcast frequency of a car, but lower than broadcast frequencies of a metro and a bus; and a broadcast frequency of a metro detected by the voice broadcast detection module is higher than broadcast frequencies of a car, a bus, and a high-speed railway. Based on this, the voice broadcast detection module may identify a riding tool based on broadcast frequencies of voice signals acquired by the microphone.

However, in some cases, a distance between bus stations is relatively short, a broadcast frequency detected by the voice broadcast detection module is relatively high. Similarly, a distance between metro stations is relatively long in some cases, and a broadcast frequency detected by the voice broadcast detection module is relatively low. As a result, a result of the voice broadcast detection module is incorrect, and the accuracy is low although riding tools can be distinguished.

In another manner, the voice broadcast detection module may extract voice content from the voice signal, and identify, based on the voice content, that the riding tool is one of a high-speed railway, a metro, a bus, and an unknown category. For example, whether there are a metro keyword, a high-speed railway keyword, and a bus keyword in the voice content is identified. This is merely an example, and details are not described in this embodiment again.

Some embodiments of this application further provide an electronic device. The electronic device may include: one or more processors and a memory. The memory is configured to store one or more pieces of computer program code, the computer program code includes computer instructions, and the computer instructions, when executed by the one or more processors, cause the electronic device to perform the riding tool identification method.

This embodiment further provides a computer-readable storage medium. The computer-readable storage medium includes instructions, and the instructions, when run on an electronic device, cause the electronic device to perform the riding tool identification method.

This embodiment further provides a computer program product including instructions, and when the computer program product runs on an electronic device, the electronic device is enabled to perform the riding tool identification method.

This embodiment further provides a control device. The control device includes one or more processors and a memory. The memory is configured to store one or more pieces of computer program code, the computer program code includes computer instructions, and the computer instructions, when executed by the one or more processors, cause the control device to perform the riding tool identification method. The control device may be an integrated circuit IC, or may be a system-on-chip SOC. The integrated circuit may be a general-purpose integrated circuit, or may be a field programmable gate array FPGA, or may be an application-specific integrated circuit ASIC.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1.-19. (canceled)

20. A method, comprising:
obtaining at least one of an acceleration signal acquired by an acceleration sensor in an electronic device or a magnetometer signal acquired by a magnetometer sensor in the electronic device;
identifying a riding tool based on at least one of an acceleration feature or a magnetometer feature, to obtain a riding classification result, wherein the acceleration feature is obtained based on the acceleration signal, and the magnetometer feature is obtained based on the magnetometer signal;
obtaining a voice signal acquired by a microphone in the electronic device, and extracting a voice feature based on the voice signal;
recognizing a voice broadcast during ride based on the voice feature, to obtain a voice broadcast recognition result; and
determining a category of the riding tool based on the riding classification result and the voice broadcast recognition result.

21. The method according to claim 20, further comprising:
before identifying the riding tool based on the at least one of the acceleration feature or the magnetometer feature, to obtain the riding classification result, detecting whether the electronic device is in a riding state;
triggering, when it is detected that the electronic device is in the riding state, the electronic device to identify the riding tool, to obtain the riding classification result; or
continuing to detect, when it is detected that the electronic device is in a non-riding state, whether the electronic device is in the riding state.

22. The method according to claim 21, further comprising:
controlling on and off of the microphone based on whether the electronic device is in the riding state; or
controlling on and off of the microphone based on a ride code push situation of the electronic device; or
controlling on and off of the microphone based on an operating status of the electronic device.

23. The method according to claim 22, wherein controlling the on and off of the microphone based on whether the electronic device is in the riding state comprises:
turning on the microphone when it is detected that the electronic device is in the riding state; or
turning off the microphone when it is detected that the electronic device is in the non-riding state.

24. The method according to claim 22, wherein controlling the on and off of the microphone based on the ride code push situation of the electronic device comprises:
turning on the microphone when it is detected that the electronic device enables a ride code push function; or
turning off the microphone when it is detected that the electronic device completes push of a ride code; and
turning on the microphone every first time period after turning off the microphone, or controlling, after turning off the microphone, on and off of the microphone based on whether the electronic device is in the riding state.

25. The method according to claim 22, wherein controlling the on and off of the microphone based on the operating status of the electronic device comprises:
turning on the microphone when the electronic device is in a screen-on state; or
turning off the microphone when the electronic device is in a screen-off state.

26. The method according to claim 21, wherein detecting whether the electronic device is in the riding state comprises:
obtaining a base station signal acquired by a modem processor in the electronic device within a preset time period;
detecting, based on the base station signal, a quantity of cells passed by the electronic device within the preset time period; and
determining, based on the quantity of cells passed by the electronic device within the preset time period, whether the electronic device is in the riding state.

27. The method according to claim 21, wherein detecting whether the electronic device is in the riding state comprises:
inputting the acceleration feature into an artificial intelligence riding state identification model to obtain a ride identifier outputted by the artificial intelligence riding state identification model, wherein the ride identifier indicates whether the electronic device is in the riding state or the non-riding state, and the artificial intelligence riding state identification model is obtained by training based on historical acceleration features of riding tools of different categories.

28. The method according to claim 20, wherein identifying the riding tool based on at least one of the acceleration feature or the magnetometer feature, to obtain the riding classification result comprises:
inputting at least one of the acceleration feature or the magnetometer feature into an artificial intelligence riding classification model to obtain the riding classification result outputted by the artificial intelligence riding classification model, wherein the artificial intelligence riding classification model is obtained by training based on at least one of historical acceleration features and historical magnetometer features of the riding tools of different categories, and the riding classification result outputted by the artificial intelligence riding classification model indicates scores of the riding tools of different categories.

29. The method according to claim 20, wherein recognizing the voice broadcast during ride based on the voice feature, to obtain the voice broadcast recognition result comprises:
inputting the voice feature into an artificial intelligence voice type recognition model to obtain the voice broadcast recognition result outputted by the artificial intelligence voice type recognition model, wherein the artificial intelligence voice type recognition model is obtained by training based on historical voice features of the riding tools of different categories, and the voice broadcast recognition result indicates a category of a riding tool corresponding to the voice feature.

30. The method according to claim 20, wherein recognizing the voice broadcast during ride based on the voice feature, to obtain the voice broadcast recognition result comprises:
recognizing the voice broadcast during ride based on a broadcast frequency of the voice signal and broadcast frequency thresholds of different riding tools, to obtain the voice broadcast recognition result, wherein the voice broadcast recognition result indicates a category of a riding tool corresponding to the voice signal.

31. The method according to claim 20, wherein recognizing the voice broadcast during ride based on the voice feature, to obtain the voice broadcast recognition result comprises:
recognizing the voice broadcast during ride based on key content of the voice signal and preset key content of different riding tools, to obtain the voice broadcast recognition result, wherein the voice broadcast recognition result indicates a category of a riding tool corresponding to the voice signal.

32. The method according to claim 28, wherein determining the category of the riding tool based on the riding classification result and the voice broadcast recognition result comprises:
determining, when a high-speed railway score is the largest in the riding classification result, and the high-speed railway score meets a first threshold condition, that the riding tool is a high-speed railway;
determining, when a metro score is the largest in the riding classification result, and the metro score meets a second threshold condition, that the riding tool is a metro;
determining, when the metro score meets a third threshold condition, and the voice broadcast recognition result is a metro broadcast voice, that the riding tool is the metro;
determining, when a bus/car score in the riding classification result meets a fourth threshold condition, and the voice broadcast recognition result is a bus broadcast voice, that the riding tool is a bus; and
determining, when the bus/car score in the riding classification result is largest, the bus/car score meets a fifth threshold condition, and the voice broadcast recognition result is not the bus broadcast voice and the metro broadcast voice, that the riding tool is a car.

33. The method according to claim 32, wherein determining, when the high-speed railway score is the largest in the riding classification result, and the high-speed railway score meets a first threshold condition, that the riding tool is the high-speed railway comprises:
determining, when the high-speed railway score is the largest in the riding classification result, the high-speed railway score meets the first threshold condition, and the base station signal comprises a high-speed railway identifier, that the riding tool is the high-speed railway, wherein the base station signal is acquired by sa modem processor in the electronic device.

34. The method according to claim 29, wherein identifying the riding tool based on the at least one of the acceleration feature or the magnetometer feature, to obtain the riding classification result comprises:
identifying the riding tool based on the magnetometer feature and magnetometer thresholds of different riding tools, to obtain the riding classification result.

35. The method according to claim 34, wherein determining the category of the riding tool based on the riding classification result and the voice broadcast recognition result comprises:
determining, when the riding classification result is a high-speed railway, that the riding tool is the high-speed railway;
determining, when the riding classification result is a metro, and the voice broadcast recognition result is a metro broadcast voice, that the riding tool is the metro;
determining, when the riding classification result is a bus or a car, and the voice broadcast recognition result is a bus broadcast voice, that the riding tool is the bus; and
determining, when the riding classification result is the bus or the car, and the voice broadcast recognition result is not the bus broadcast voice and the metro broadcast voice, that the riding tool is the car.

36. The method according to claim 35, wherein determining the category of the riding tool based on the riding classification result and the voice broadcast recognition result comprises:
determining, when the base station signal comprises a high-speed railway identifier, that the riding tool is the high-speed railway, wherein the base station signal is acquired by a modem processor in the electronic device.

37. An electronic device, comprising:
one or more processors and a memory, wherein the memory is configured to store one or more pieces of computer program code, the computer program code comprises computer instructions, and the computer instructions, when executed by the one or more processors, cause the electronic device to perform the following:
obtaining at least one of an acceleration signal acquired by an acceleration sensor in an electronic device or a magnetometer signal acquired by a magnetometer sensor in the electronic device;
identifying a riding tool based on at least one of an acceleration feature or a magnetometer feature, to obtain a riding classification result, wherein the acceleration feature is obtained based on the acceleration signal, and the magnetometer feature is obtained based on the magnetometer signal;
obtaining a voice signal acquired by a microphone in the electronic device, and extracting a voice feature based on the voice signal;
recognizing a voice broadcast during ride based on the voice feature, to obtain a voice broadcast recognition result; and
determining a category of the riding tool based on the riding classification result and the voice broadcast recognition result.

38. A computer-readable storage medium, comprising instructions, the instructions, when run on an electronic device, causing the electronic device to perform the following:
obtaining at least one of an acceleration signal acquired by an acceleration sensor in an electronic device or a magnetometer signal acquired by a magnetometer sensor in the electronic device;
identifying a riding tool based on at least one of an acceleration feature or a magnetometer feature, to obtain a riding classification result, wherein the acceleration feature is obtained based on the acceleration signal, and the magnetometer feature is obtained based on the magnetometer signal;
obtaining a voice signal acquired by a microphone in the electronic device, and extracting a voice feature based on the voice signal;
recognizing a voice broadcast during ride based on the voice feature, to obtain a voice broadcast recognition result; and
determining a category of the riding tool based on the riding classification result and the voice broadcast recognition result.
